(19) United States
(12) Patent Application Publication
(10) Pub. No.: US 2008/0115754 A1
(43) Pub. Date: May 22, 2008

(54) Induction Regulator for an Internal Combustion Engine

(76) Inventor: Richard James Facer, Newport (GB)

Correspondence Address: ARENT FOX LLP, 1050 CONNECTICUT AVENUE, N.W., SUITE 400, WASHINGTON, DC, 20036, US

(21) Appl. No.: 11/629,319

(22) PCT Filed: Jun. 9, 2005
(86) PCT No.: PCT/GB05/02255

§ 371 Date: Nov. 26, 2007

(30) Foreign Application Priority Data
Apr. 27, 2005 (GB) 0508559.2
Jun. 14, 2006 (GB) 0413184.3

(51) Int. Cl. F02M 35/10

(52) U.S. Cl. 123/184.46; 261/38

(57) ABSTRACT

An induction regulator (1) for an internal combustion engine is described wherein the regulator (1) comprises at least one perforated member (6) means for locating said perforated member (6) in the inlet manifold of an engine and further comprising adjustment means (10) to permit the angle of the perforated member (6) to be varied with respect to the inlet manifold. An induction regulator (1) apparatus is also described along with retro-fit comprising an induction regulator of the present invention as well as a method of improving the fuel efficiency of an engine using an induction regulator (1) of the present invention.

### FIELD OF THE INVENTION

The present invention relates to an induction regulator for an internal combustion engine.

### BACKGROUND

For an internal combustion engine to operate correctly, say a petrol engine, it is important that the fuel and air mixture being introduced into the cylinder prior to being burned is well mixed and suitably proportioned.

In the operation of an engine, fuel is extracted from the fuel tank and pumped through lines past a filter and either to a carburettor or fuel injector. In both cases, the fuel is emitted from there into an inlet manifold (sometimes referred to as inlet pipe, intake manifold, intake tract, etc) from where it enters a cylinder upon opening of the intake valve in order to be burned.

An induction regulator is typically a device disposed downstream from a carburettor or single point injection system of an internal combustion engine and is adapted to compensate for irregularities in the supply and demand for fuel from the engine. The purpose of the induction regulator being the efficient burning of the fuel and, thus, improved fuel consumption.

There are several known induction regulators such as that described in UK patent application no. 2099074. The known regulators described in this document have perforated members disposed in the inlet manifold in the flow of the fuel/air mixture. The perforations facilitate the vaporisation of the fuel so that the fuel/air mixture is enhanced which produces a more efficient burn in the cylinder and, thus, better fuel efficiency from the engine.

There are several drawbacks with these known regulators however. One drawback is that the correct fitting of the regulator if often found to be extremely difficult, particularly if the perforated member is to be disposed at the optimum angle. These regulators are located in the inlet manifold by folding the straps over the outer sides of the manifold and clamping the regulator to the manifold with a gasket. This can often result in a hit-or-miss fitting arrangement. Also, the straps may be prone to mechanical failure which could result in the regulator falling into the engine.

The drawbacks mentioned above have been largely addressed in UK patent no. 2383607. These known regulators also have perforated members disposed in the inlet manifold in the flow of the fuel/air mixture during operation of the engine. These regulators facilitate greater precision in the fitting of the regulator but, nevertheless, an improved induction regulator is desired.

It is an object of the present invention to provide an improved induction regulator.

### SUMMARY OF THE INVENTION

According to the first aspect of the present invention there is provided an induction regulator for an internal combustion engine, wherein the regulator comprises at least one perforated member, means for locating said perforated member in the inlet manifold of an engine and further comprising adjustment means to permit the angle of the perforated member to be varied with respect to the inlet manifold.

The regulator of the present invention is advantageous in that it provides the ability to adjust the angle of the at least one perforated member after it has been fitted. Consequently, the adjustment of the angle in situ will ensure that the optimum setting for the efficient burning of the fuel can be achieved.

Preferably the adjustment means are configured to permit the manual adjustment of the at least one perforated member.

Alternatively, the adjustment means are configured to permit the automatic adjustment of the at least one perforated member. Any automatic adjustment may be achieved by the adjustment means being under the control of an electronic engine management system. Conversely, any automatic adjustment may be achieved by the adjustment means being in mechanical communication with a cam shaft, cam pin, crank shaft, throttle or other moving part in the engine.

As a further alternative, the adjustment means may be configured to permit the manual and/or the automatic adjustment of the at least one perforated member.

In a preferred embodiment of the present invention the adjustment means are configured to be operable in direct response to the speed of the engine. For instance, when the engine is at high speed, i.e. operating at high revolutions, the adjustment means may be operable to increase the angle of the perforated member(s).

The engine may be provided with sensors downstream of the induction regulator or inlet manifold to monitor the efficiency of the engine. Said sensors could be utilised to operate or assist in the operation of the adjustment means, wherein any adjustment can be provided to facilitate an optimum angle. Any adjustment could be provided on a constant or routine basis in order to adjust the angle in response to a reduction of efficiency.

The adjustment means may be operable to adjust the angle of the at least one perforated member through a full 360°. Preferably however, the adjustment means may be operable to adjust the angle from 0° through to 90°. Even more preferably, the adjustment means may be operable to adjust the angle from 10° through to 40°. In the most preferred embodiment, the adjustment means may be operable to adjust the angle from 15° through to 30°.

Preferably the at least one perforated member defines a plurality of elongate passages therethrough. This elongation may assist in the conditioning the flow of the fuel/air mix to create a vortex or a substantially swirling motion of the mix as it leaves the at least one perforated member. It is believed that a vortex or swirling motion leads directly to an improved burn of the fuel.

In one embodiment of the present invention, the perforated member may comprise a plurality of perforated members. Preferably said plurality of perforated members are located adjacent or substantially adjacent each other.

The perforated member(s) may be made from a substantially flat plate or sheet material. The perforations may be made via any suitable method.

Alternatively, the perforated member(s) may be made from a mesh material, the mesh material may be woven.

Preferably the perforated member(s) are made from any suitable engine-grade metal, preferably stainless steel or aluminium. Alternatively, the perforated member(s) may be made from any suitable engine-grade plastics material. The term “engine-grade” in the context of the present invention is understood to mean that the material is suitable for use in the interior of an engine and is not degraded or corroded on exposure to petroleum products and the like.

In a preferred embodiment of the present invention, the perforated member(s) may have a substantially circular shape. Alternatively, the perforated member(s) may have a shape that substantially mirrors the contours of the inlet manifold.

The at least one perforated member is preferably held by a circumferential frame. Where there are a plurality of perforated members, the circumferential frame may by used to hold the members in an adjacent orientation with respect to each other.

Ideally, the present invention provides an induction regulator body with an inner chamber to house the at least one perforated member. The body may be formed in any shape suitable to facilitate the ease of releasably engagement with the inlet manifold. Preferably the inner chamber is sized to provide substantially identical dimensions to the inner dimensions of the inlet manifold. Alternatively, the inner chamber may be sized to possess greater inner dimensions than the inner dimensions of the inlet manifold in order to guard against any choking-effect due to any impediment caused to the flow of the fuel/air mix arriving at the induction regulator when the engine is in use.

The induction regulator body may be arranged so that it is mountable on or around the entrance to the inlet manifold. For instance, the mounting may be achieved by any suitable fixing, such as with the use of gaskets and screws or adhesive.

Alternatively, the induction regulator body may be arranged to facilitate mounting within the interior of the inlet manifold. In this arrangement, the body would be secured in the manifold by any suitable fixing means, such as by screws, pins extending through to the exterior of the manifold, or by an adhesive. In this arrangement, apertures may be provided in the inlet manifold to permit the operation of the adjustment means.

The body may be made from any suitable engine-grade metal or plastics material.

Preferably the body is constructed in two parts. These two parts, once made, may then be attached together by any suitable fixing means, this attachment preferably facilitating the location of the perforated member(s) within the body's inner chamber.

Alternatively, the body may constructed from three or more parts. These three parts may consist of a central body member to which the perforated member(s) are mounted, and an upper and lower body member which can be fixed together such that the central body member is sandwiched therebetween, similarly any suitable fixing means may be used to fix the body members.

Where the body is constructed from more than one part, gaskets and the like may be used in order to ensure that the attachment of the parts is suitably secure.

As a further alternative, the body may be constructed in a single piece.

Preferably the at least one perforated member is located in the inner chamber of the induction regulator body by attachment of the circumferential frame to the body. The circumferential frame may be attached to the adjustment means which, in turn, locate the at least one perforated member to the body. Alternatively, the frame may be located in the inner chamber by retaining pins which may be in operative communication with the adjustment means.

It is preferred that the circumferential frame is sized to provide a gap between a majority of its periphery and the inner surface of the chamber or manifold. Where no frame is present, the gap may be between the periphery of the perforated member(s) and the inner surface of the chamber or manifold. This gap may be operable when the engine is in use to prevent the engine suffering a choking-effect due to any impediment caused to the flow of the fuel/air mix arriving at the induction regulator. In a preferred embodiment of the present invention the gap may be present around the entire periphery of the frame or perforated member(s), save for where any attachment means, retaining pins or adjustment means are present to locate the perforated member(s) in the inner chamber or manifold.

The gap between the entire periphery of the frame or perforated member(s) and the inner surface of the chamber or manifold may vary depending on the angle at which the perforated member(s) is disposed. However, portions of the periphery of the frame or perforated member(s) that are secured, to attachment means, retaining pins or adjustment means in order to locate the member(s) in the inner chamber or manifold may be at a fixed distance therefrom, i.e. a fixed gap. The member(s) may rotate on the axis defined by said portions. The fixed gap may be in the range of between 1 mm-20 mm. Preferably the size of the fixed gap is between 2 mm-10 mm. Most preferred however is for the size of the fixed gap to be between 4 mm-6 mm.

The induction regulator of the present invention may work in co-operation with a beading or the like located upstream of the regulator. The beading may be provided on a gasket or, alternatively, on the induction regulator body. Said beading may be configured to extend into the inner chamber or manifold. Advantageously, this beading may be effective, when the engine is in use, to direct any unvaporised fuel on the inner surface of the chamber or manifold on to the perforated member(s), thus ensuring the vaporisation of said fuel. The beading may extend into the chamber or manifold by upto 5 mm, but preferably extend between 1 mm-2 mm.

The inner surfaces of the induction regulator are preferably provided with a substantially spiral component. The spiral component may be an externally protruding thread or an internally recessed groove. The spiral component has the ability to enhance the vortex formed by the fuel/air mixture passing there in use and, thus, enhance any vaporisation of said fuel. The externally protruding thread of the spiral component may extend from the surface of the inner chamber by between 1 mm-2 mm. Alternatively, recessed groove of the spiral component may be recessed into the surface of the inner chamber by between 1 mm-2 mm.

In a preferred embodiment of the present invention the at least one perforated member is in thermal communication with a heat source. The heat source may be provided in the form of one or more heat pads located outside the inner chamber or manifold. Alternatively heat pads may be imbedded within the frame or between the perforated members when a plurality are present.

Thermal communication may be achieved by direct application of heat from the heat pads to the at least one perforated member. Preferably the thermal communication is achieved via conduction wherein the heat is transferred to the at least one perforated member via the heating of the adjustment means and/or the retaining pins and/or via the frame.

Alternatively or additionally, the heat source may be a water jacket surrounding the induction regulator body or portion of the manifold where the regulator is to be located. Heated water may be pumped from the engine's cooling system to heat the jacket and the conduction and convection of this heat will cause the perforated member(s) within the body or manifold as well as the inner surface of the body or manifold to heat up.

The induction regulator of the present invention may also be provided with a reservoir member located adjacent the at least one perforated member downstream thereof with respect to the flow of the fuel/air mix when the engine is in use. The reservoir member may have perforations therein and may be open topped. Preferably the reservoir member would be no wider than 33% of the diameter of the perforated member(s) at its uppermost end and no wider than 25% of said diameter at its lower end. In embodiments of the present invention where a plurality of perforated members are present, the reservoir member may be used to secure the members in adjacent confirmation to each other.

The reservoir member may be adapted, in use, to collect unvaporised fuel such that when the engine requires additional fuel, the collected fuel may be vaporised by passing through the regulator, being vaporised as a consequence and passing back through the gap and toward the cylinder to be burned.

According to a second aspect of the present invention there is provided an induction regulator for an internal combustion engine, wherein the regulator defines an chamber in which is disposed at least one perforated member, means for locating said perforated member in the inlet manifold of an engine and wherein inner walls of the chamber have a substantially spiral component.

According to a third aspect of the present invention there is provided an induction regulator apparatus for an internal combustion engine, wherein the regulator comprises a body with an inner chamber to house at least one perforated member, means for locating said perforated member in the inlet manifold of an engine and further comprising adjustment means to permit the angle of the perforated member to be varied with respect to the inlet manifold.

According to a fourth aspect of the present invention there is provided a retro-fit kit for an internal combustion engine, wherein said kit comprises an induction regulator for an internal combustion engine and fixing means to attach said induction regulator to said engine, wherein the regulator comprises at least one perforated member, means for locating said perforated member in the inlet manifold of an engine and further comprising adjustment means to permit the angle of the perforated member to be varied with respect to the inlet manifold.

According to a fifth aspect of the present invention there is provided a retro-fit kit for an internal combustion engine, wherein said kit comprises an induction regulator and fixing means to attach said induction regulator to said engine, wherein said regulator comprises a body with an inner chamber to house at least one perforated member, means for locating said perforated member in the inlet manifold of an engine and further comprising adjustment means to permit the angle of the perforated member to be varied with respect to the inlet manifold.

According to a sixth aspect of the present invention there is provided an internal combustion engine, wherein the engine comprises an induction regulator, said induction regulator comprising at least one perforated member, means for locating said perforated member in the inlet manifold of an engine and further comprising adjustment means to permit the angle of the perforated member to be varied with respect to the inlet manifold.

According to a seventh aspect of the present invention there is provided a method of improving the efficiency of an internal combustion engine, said method comprises the fitting of an induction regulator wherein the regulator is in accordance with one of the first or third aspects of the present invention, and adjusting the angle of the at least one perforated member whilst the induction regulator remains fitted to said engine.

### BRIEF DESCRIPTION OF THE DRAWINGS

To allow the present invention to be more readily understood, a description of specific embodiments thereof shall now be described with reference to the accompanying drawings in which:

FIG. 1 illustrates a plan view of an induction regulator body according to a first aspect of the present invention;

FIG. 2 also illustrates a plan view of an induction regulator body according to a first aspect of the present invention;

FIG. 3 illustrates a plan view of a perforated member; and

FIG. 4 illustrates a side view of a an induction regulator body.

### DESCRIPTION OF AN EMBODIMENT

FIGS. 1 and 2 illustrate two halves of an induction regulator body 1. The body 1 has a central aperture running therethrough that defines an inner chamber 2. The inner chamber 2 is sized to provide substantially identical dimensions to the inner dimensions of an inlet manifold (not shown). The body 1 has a series of securing holes 3 that allow two separate bodies to be secured together. At least one, or possibly both, of the bodies also contains channels 4, although only one of the bodies 1 is shown having these channels 4.

The bodies 1 each have two apertures 5 to permit the body to be securely fixed to the engine by screws or such like. The induction regulator can be securely fixed downstream from a carburettor/single point injection system/throttle body injection system and upstream of a cylinder(s) of the engine.

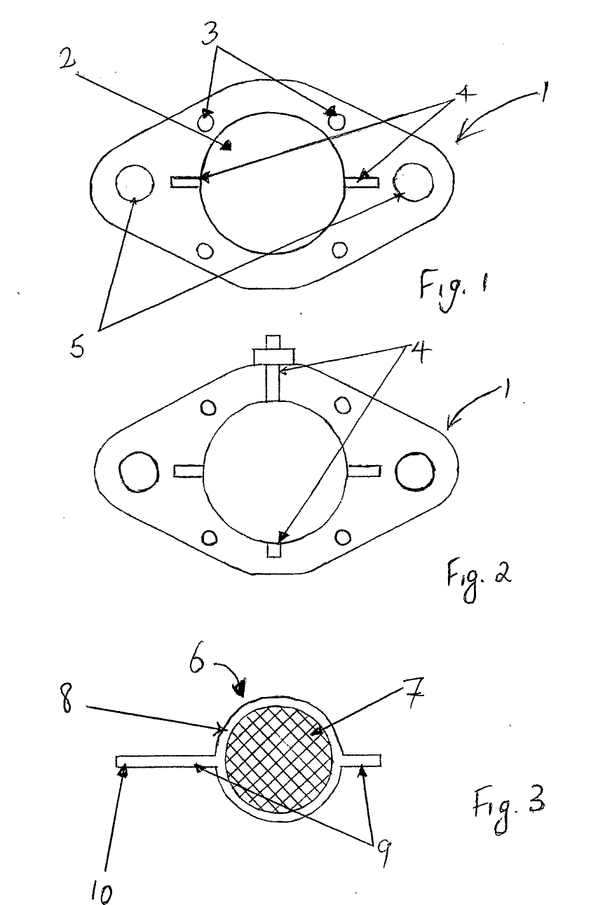

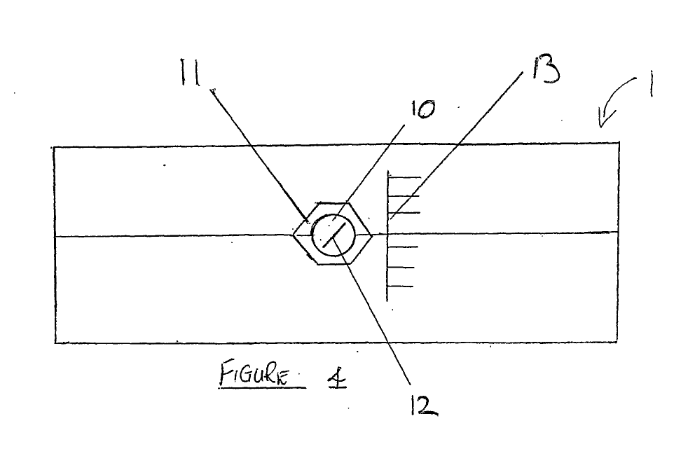

FIG. 3 shows a perforated member 6. The perforated member 6 has a generally circular perforated mesh 7 which is secured at is periphery by a circumferential frame 8. The perforated member 6 defines a plurality of elongate passages therethrough. This elongation is thought to assist in the conditioning the flow of the fuel/air mix to create a vortex or a substantially swirling motion of the mix as it leaves the perforated member 6. It is believed that a vortex or swirling motion leads directly to an improved burn of the fuel.

Although not shown, the perforated member 6 consists of perforated meshes 7 located adjacent each other to define the plurality of elongate passages therethrough.

There is a radial gap between the periphery of the frame 8. The gap is in the range of between 1 mm-20 mm. This gap may be operable when the engine is in use to prevent the engine suffering a choking-effect due to any impediment caused to the flow of the fuel/air mix arriving at the induction regulator.

The frame 8 possesses two arms 9 extending to opposite sides of the frame 8 to permit a connection of the perforated member 6 to the body 1. One of the arms 9 may be elongate to provide an adjusting arm 10.

As can be seen from viewing all of FIGS. 1-3, to assemble an induction regulator in accordance with the present invention, the perforated member 6 is connected to a body 1 by locating the arms 9 in the corresponding channels 4 in one of the bodies 1. A second body member is then located such that the perforated member is sandwiched there between. Spigot pins and co-operating holes may be provided on the body members to facilitate the correct alignment of the two body members 1 relative to each other. Once the two bodies are aligned, and the perforated member 6 is located therebetween, screws or the like can pass through the securing holes 3 to securely fasten the bodies 1 to each other.

Once the two bodies are fixed together, the adjusting arm 10 protrudes to the exterior of the bodies 1. This arrangement allows for the adjusting arm to be rotated from the exterior of the body and thus rotates the perforated member via rotation of the two arms 9 in the corresponding channels 4.

With reference to FIG. 4, a side view of two bodies securely fixed together can be seen with the adjusting arm 10 protruding to the exterior thereof. A lock nut 11 is provided around the exterior of the adjusting arm in order to restrict the rotational movement thereof.

The end of the adjusting arm can include a pointer 12. The pointer 12 can point toward a calibration gauge 13 located on the exterior of the bodies 1. The calibration gauge 13 may comprise suitable markings to allow the user of an induction regulator of the present invention to know or have an indication of the angle at which the perforated member 6 is disposed within the inner chamber 2.

Once the two bodies 1 are fixed to each other, thus sandwiching the perforated member 6 therebetween, the induction regulator can be secured by suitable fixings through the apertures 5 to the engine between the carburettor or single point injection system and the cylinder.

Although not shown, a beading or the like can be located upstream of the perforated member 6. The beading can extend into the inner chamber 2 to direct any unvaporised fuel on the inner surface of the chamber or manifold on to the perforated member 6, thus ensuring the vaporisation of said fuel. The beading can extend into the chamber or manifold by upto 5 mm, but preferably extend between 1 mm-2 mm.

In operation, the engine can be run and the angle of the perforated member can now be adjusted whilst the induction regulator is in situ. This operation is facilitated by manually rotating the adjusting arm 10 and/or lock nut, thus altering the angle of the perforated member and allowing the provision of the optimum angle for the particular engine to which the regulator is connected.

The inner surfaces of the induction regulator can be provided with a substantially spiral component, not shown. The spiral component may be an externally protruding thread or an internally recessed groove. The spiral component has the ability to enhance the vortex formed by the fuel/air mixture passing there in use and, thus, enhance any vaporisation of said fuel. The externally protruding thread of the spiral component may extend from the surface of the inner chamber by between 1 mm-2 mm. Alternatively, recessed groove of the spiral component may be recessed into the surface of the inner chamber by between 1 mm-2 mm.

Although not shown, the perforated member 6 can be in thermal communication with a heat source. The heat source can be provided in the form of one or more heat pads located outside the inner chamber 2 or manifold. Alternatively heat pads may be imbedded within the frame 8 or between the perforated members 6.

Thermal communication may be achieved by direct application of heat from the heat pads to the perforated members 6. The thermal communication is achieved via conduction wherein the heat is transferred to the at least one perforated member via the heating of the adjustment means and/or the retaining pins and/or via the frame.

Also, although not shown, the heat source may be a water jacket surrounding the induction regulator body or portion of the manifold where the regulator is to be located. Heated water can be pumped from the engine's cooling system to heat the jacket and the conduction and convection of this heat will cause the perforated member 6 within the body 1 as well as the inner chamber 2 to heat up.

An embodiment of the invention has been described above by way of example. It would be appreciated that various modifications to that which have been specifically described can be made without departing from the invention.

For instance, a diaphragm in control of a vacuum may be provided, this diaphragm being operate to control the angle of the perforated member(s) at varying engine speed via the control of said vacuum.

1-20. (canceled)

21. An induction regulator for an internal combustion engine, wherein the regulator comprises at least one perforated member, means for locating said perforated member in the inlet manifold of an engine and further comprising adjustment means to permit the angle of the perforated member to be varied with respect to the inlet manifold.

22. An induction regulator according to claim 21, wherein the adjustment means are configured to permit the manual adjustment of the at least one perforated member.

23. An induction regulator according to claim 21, wherein the adjustment means are configured to permit the automatic adjustment of the at least one perforated member.

24. An induction regulator according to claim 21, wherein the adjustment means are configured to permit the manual and/or the automatic adjustment of the at least one perforated member.

25. An induction regulator according to claim 21, wherein the adjustment means are configured to be operable in direct response to the speed of the engine.

26. An induction regulator according to claim 21, wherein the angle of the at least one perforated member is adjustable through 360°.

27. An induction regulator according to claim 21, wherein the angle of the at least one perforated member is adjustable from 0° through to 90°.

28. An induction regulator according to claim 21, wherein the angle of the at least one perforated member is adjustable from 10° through to 40°.

29. An induction regulator according to claim 21, wherein the at least one perforated member defines a plurality of elongate passages therethrough.

30. An induction regulator according to claim 21, wherein a plurality of perforated members are provided.

31. An induction regulator according to claim 21, wherein the at least one perforated member is held by a circumferential frame.

32. An induction regulator according to claim 21, wherein an induction regulator body with an inner chamber to house the at least one perforated member is provided.

33. An induction regulator according to claim 21, wherein a beading is located upstream of the regulator.

34. An induction regulator according to claim 21, wherein the inner surfaces of the induction regulator are provided with a substantially spiral component.

35. An induction regulator according to claim 34, wherein the spiral component is an externally protruding thread and/or an internally recessed groove.

36. An induction regulator according to claim 34, wherein the spiral component extend or recess from the surface of the inner chamber by between 1 mm-2 mm.

37. An induction regulator according to claim 21, wherein the at least one perforated member is in thermal communication with a heat source.

38. An induction regulator according to claim 21, wherein a reservoir member is provided adjacent the at least one perforated member.

39. An induction regulator according to claim 38, wherein reservoir member has perforations therein and/or is open topped.

40. An induction regulator for an internal combustion engine, wherein the regulator defines a chamber in which is disposed at least one perforated member, means for locating said perforated member in the inlet manifold of an engine and wherein inner walls of the chamber have a substantially spiral component.
